(19) United States
(12) Patent Application Publication
(10) Pub. No.: US 2014/0028255 A1
(43) Pub. Date: Jan. 30, 2014

(54) NETWORKED UNIVERSAL ELECTRIC VEHICLE CHARGING SYSTEM

(71) Applicant: Bruce Brimacombe, Mesa, AZ (US)

(72) Inventor: Bruce Brimacombe, Mesa, AZ (US)

(21) Appl. No.: 13/950,214

(22) Filed: Jul. 24, 2013

Related U.S. Application Data
(60) Provisional application No. 61/675,809, filed on Jul. 25, 2012.

(51) Int. Cl. B60L 11/18

(52) U.S. Cl. CPC B60L 11/1824
USPC 320/109

(57) ABSTRACT

An electric vehicle charging station system has numerous charging nodes, each charging node including a charging station having at least two electric vehicle supply equipment selected from the group consisting of a Level 1 charging device, a Level 2 charging device, a TESLA charging device, and a Level 3/Fast DC charging device, wherein the plurality of charging nodes are in communication with each other through a network. A display device is disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle. A selection device allows the consumer to select a particular portal, wherein the selection device transmits the selected content to a mobile device associated with the consumer.

### RELATED APPLICATIONS

This application claims the benefit of pending U.S. Provisional Patent Application No. 61/675,809, filed on Jul. 25, 2012, which is hereby incorporated by reference.

### TECHNICAL FIELD

The inventions described herein are directed to charging nodes for networked electric vehicle (EV) and to charging stations having at least two different types of charging connectors and the ability for a consumer to receive web-based or consumer-focused information.

### BACKGROUND

Electric vehicles (EV), much like the conventional internal combustion engine powered vehicles, have a finite range. EVs are three to five times more efficient as internal combustion vehicles, cost less to drive and maintain, and offer zero air pollution. In spite of these advantages, the market penetration of EVs is hindered by the limited number of charging options available outside the urban city regions. There are numerous petroleum refueling spots along interstates, state highways and large secondary roads allowing people to travel between cities and states using conventional vehicles. However, there are very few EV charge stations on the highway and freeway systems, and currently there is no network allowing EV drivers to travel coast to coast or even between states. For this EV technology to succeed, a large scale charging network is vital. Further, conventional economics stifle the progress of such a network inception, and a new multi-facet solution is needed.

### SUMMARY

In one embodiment there is disclosed an electric vehicle charging station system comprising a) a plurality of charging nodes, each charging node including a charging station having at least two electric vehicle supply equipment selected from the group consisting of a Level 1 charging device, a Level 2 charging device, a TESLA charging device, and a Level 3/Fast DC charging device, wherein the plurality of charging nodes are in communication with each other through a network; b) a display device disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle; and c) a selection device that allows the consumer to select a particular portal , wherein the selection device transmits the selected content to a mobile device associated with the consumer.

### BRIEF DESCRIPTION OF THE DRAWINGS

FIG. 1A is an overview that shows a U.S. map and possible recharging station linkages. FIG. 1B is a schematic of a charging station.

FIG. 2 shows a “GOe3 Universal Quick Charging Station” system 50 that forms a part of each node 12, 14, 16, etc.

FIG. 3 shows a schematic of the charging station displaying web- or consumer-centric content.

### DETAILED DESCRIPTION OF EMBODIMENTS

For EV technology to succeed, a large scale charging network is vital. Further conventional economics stifle the progress of such a networks inception, and a new multi-facet solution is needed. Even for EVs having a large mileage capability, such as the TESLA ROADSTER® automobile that has a 240-mile range on a signal charge, it became evident that even with such a great range, they are still bounded to urban travel only. I realized that if EVs are going to become a fully functional part of American life, their needs to be a coast to coast charging network. In doing the economics, I could see that EV chargers were not viable in a classical model, and the integration of web services and content was vital to balance the initial cost of the system. As used herein, “EV” includes all types of vehicles that use electrical energy to provide locomotion, including, but not limited to, all-electric vehicles and hybrid vehicles. The system allows the consumer to view regional information, amongst other web-content, and choose to have select information sent to their mobile device.

Currently, there are three types of charging connectors used to recharge the batteries of EVs. These include Level 1, Level 2 and Level 3/Direct-current (DC) fast charging:
a) Level 1 provides charging through a 120 volt (V) AC plug and requires electrical installation per the National Electrical Code. Most, if not all, EVs will come with a Level 1 cord set so that no additional charging equipment is required. On one end of the cord is a standard, three-prong household plug (NEMA 5-15 connector). On the other end is a JI 772 standard connector, which plugs into the vehicle. Level 1 is typically used for charging when there is only a 120 V outlet available. Based on the battery type and vehicle, Level 1 charging adds about 2 to 5 miles of range to an EV per hour of charging time.
b) Level 2 equipment offers charging through 240 V (typical in residential applications) or 208 V (typical in commercial applications) electrical service. Level 2 charging requires installation of home charging or public charging equipment and a dedicated circuit of 20 to 80 amps, depending on the EV requirements. This charging option can operate at up to 80 amperes and 19.2 kW. However, most residential Level 2 charging equipment will operate at lower power. Many such units operate at up to 30 amperes, delivering 7.2 kW of power. These units require a dedicated 40 amp circuit. Most homes have 240 V service available, and because Level 2 charging equipment can easily charge a typical EV battery overnight, this will be a common installation for homes. Level 2 equipment also uses the same connector on the vehicle as Level 1 equipment. Based on the battery type and circuit capacity, Level 2 adds about 10 to 20 miles of range per hour of charging time, depending on the vehicle.
c) Level 3, also known as Direct-current (DC) fast-charging equipment (480 V AC or 208 V AC three phase input) enables rapid charging along heavy traffic corridors and at public stations. A DC fast charge can add 60 to 80 miles of range to a light-duty EV in about 20 minutes.

Inductive charging equipment, which uses an electromagnetic field to transfer electricity to a EV without a cord, is still being used in certain areas where it was installed for EVs in the 1990s. Currently available plug-in vehicles do not use inductive charging, but SAE International is working on a standard that may apply in the future. See http ://www.afdc.energy. gov.

Most modern charging equipment and EVs have a standard connector and receptacle based on the SAE JI 772 standard developed by SAE International. Any vehicle with this plug receptacle should be able to use any JI 772-compliant Level 1 or Level 2 charging equipment. All major vehicle and charging system manufacturers support this standard in the U.S., which should eliminate drivers' concerns about whether their vehicles are compatible with the infrastructure. Some currently available plug-in vehicles that are equipped to accept DC fast charging are using the CHAdeMO connector. SAE International is also working on a “hybrid connector” standard for fast charging that adds high-voltage DC power contact pins to the JI 772 connector, enabling use of the same receptacle for all levels of charging. See http://www.afdc.energy.gov. TESLA MOTORS® company refers to its plug as “The Universal Mobile Connector” plug or port.

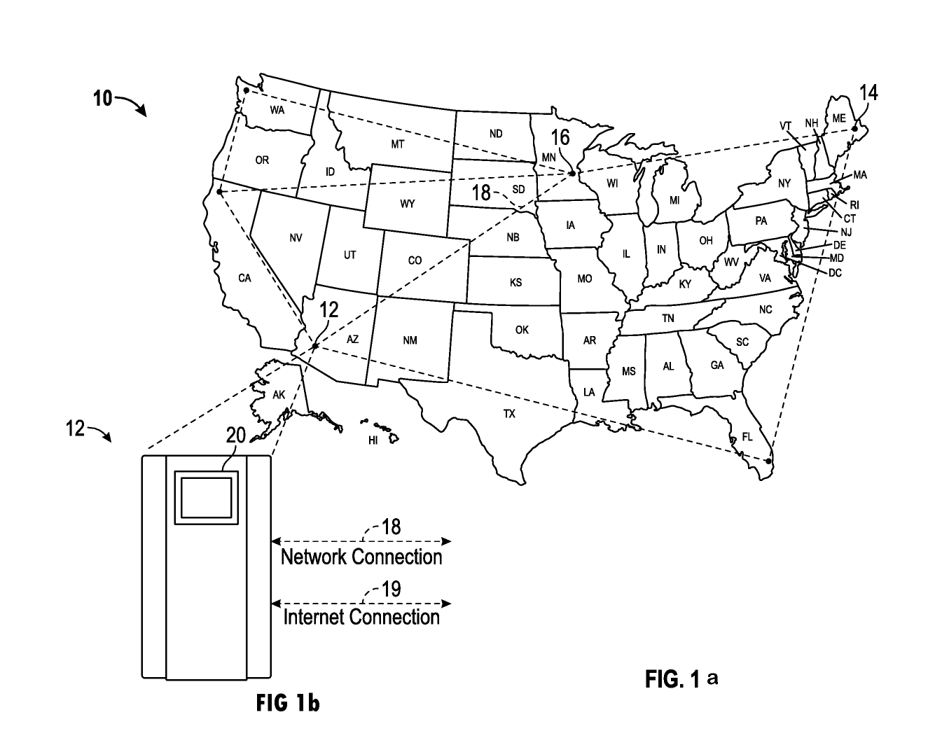

In one embodiment as shown in FIG. 1A, a universal charging node/system 10 includes many individual charging nodes 12, 14, 16, etc. spanning across more than one state linking together EV vehicle charging stations and forming a coast to coast network across the United States. As shown in FIG. 1B, each node includes at least one Level 3 and/or Level 2 charging station(s). Each node also includes a display device 20 connected to the internet and is capable of interchanging web-based content and information. Each node 12, 14, 16, etc. communicates through a wired, WiFi, or cell phone communication system 18 and to the internet 19 as an integral part of the network. Nodes receive and report all activity experienced doing operation.

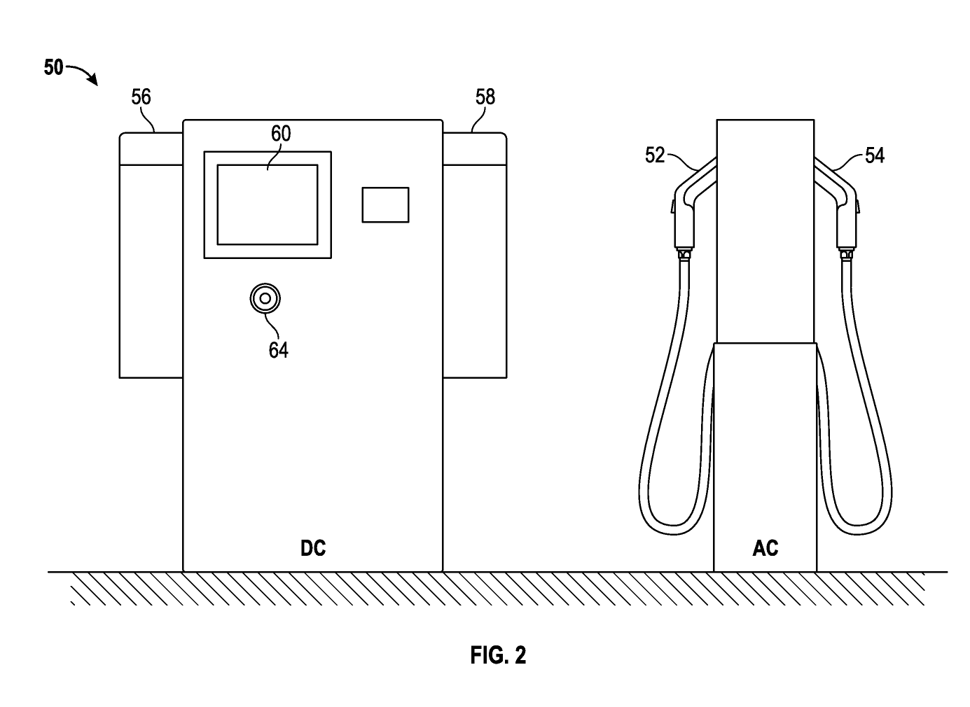

FIG. 2 shows a “GOe3™ Universal Quick Charging Station” system 50 that forms a part of each node 12, 14, 16, etc. These may be catalog numbers “u” universal, “s” stand alone, or “E3” for full level 3/2 universal and E2 for Level 2 charging station. In this embodiment, at least two or more connector interfaces are included to allow power delivery to EVs with any one or more matching plug type. The charging station 50 includes a J-1772A or JI 772E connector 52, a TESLA® connector 54, a CHAdeMO connector 56, and a J-1772E combo connector 58. The J-1772E combo is not a standard yet and does not have an official designation. It has been referred to as J-1772 Combo or J-1772 DC. The connector location depicted by the drawing is for illustration only and does not solidify a design specification, i.e. the plug type and side location may be changed if needed. Currently, a J-1772E connector 58 is a planned future install to the system 50 when it becomes a standard. The quick-charging station system 50 has the ability to deliver both Level 3 DC to DC quickcharge and Level 2 AC to DC (up to 70 Amps delivery). The quick-charging station system 50 can charge at least two EVs simultaneously.

The quick-charging station system 50 includes a touch-screen device 60 that allows the consumer/user to receive, send, and interact with web-delivered media and content. The touch-screen device 60 includes a 15 inch (diagonal) or larger touch screen. An interface is interconnected with the GOe3 quick-charging station system 50 using Webportal, Small Business Portal, mobile app services and the like. The quick-charging station system 50 further includes a “GimmE” button 64 that allows a consumer/user to select an item displayed on the touch screen 60. The GimmE button 64 is an activator that causes selected web content to be sent to a GOe3 mobile application on the consumer's/user's patron's phone. The button 64 may be a physical depressible button or a screen-represented button.

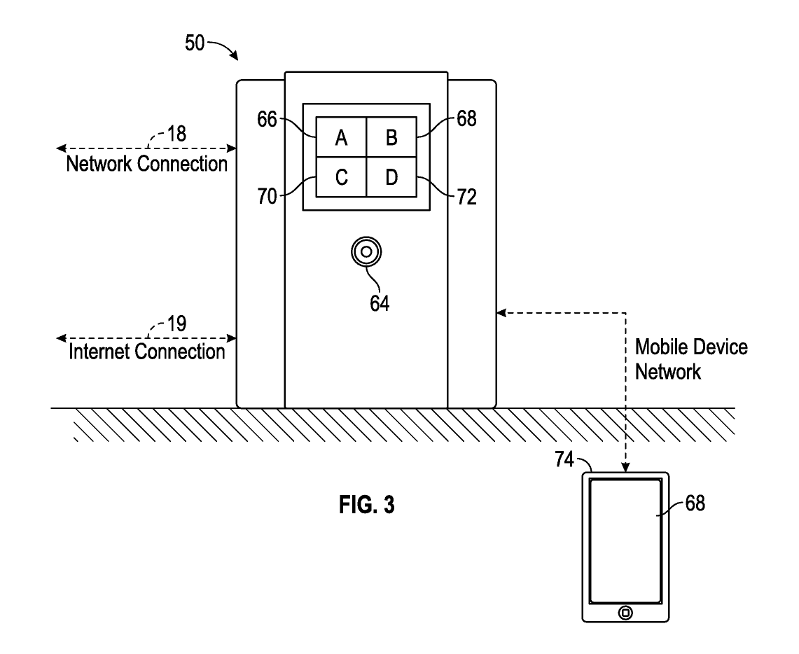

Web-based or consumer-focused content is displayed on the touch screen 60 using multiple portals 66, 68, 70 and 72, as shown in FIG. 3. This allows many web feeds, email, ads, entertainment, web commerce, social media, and any other type of consumer-focused content (represented as 66, 68, 70 and 72 on FIG. 3) to be simultaneously displayed to the consumer/user. One type of consumer-focused content that may be displayed on one of the portals is the location and distance to adjacent charging nodes. When the consumers/users see an ad or other web content that interests them, they would push the “GimmE” button 64 causing a copy of the web content to be sent to their mobile device 74. The mobile device includes but is not limited to a smart phone, tablet, laptop and the like. A mobile application that is compatible with the GOe3™ interface is installed on the mobile device that is linked to the customer's ID number, allowing for routing of the selected web content to their mobile device.

A type of interface that can be used with the quick-charging station system 50 is a small business portal (SBP). The SBP is a service that allows businesses selling goods or services to advertise through the GOe3 E3/E2 quick-charging station system 50. A key differentiator of a SBP is that the marketing information provided by the small business is concentric to the charging station 50 up to a set distance. As an example, data concerning a restaurant located approximately 10 miles from a charging station 50 are displayed, but a different restaurant located 25 miles, 50 miles and like was not be displayed on that charging station 50. This allows the customer to receive advertising that is regional to a particular charging station 50. The web content that is displayed may be defined as being within a predetermined distance to the business being served. The concentric mile ranges are up to about 35 miles, as the chargers are going to be placed every 50 to 70 +/− 10 miles. Concentric advertising offers a lower price point with greater effective targeting. While charging their EVs, the customers will see one or more ads for goods and services regional to that charging station 50.

The business and points of interest at present are limited by their owners' ability to pay. For example, a small bed and breakfast must pay tens of thousands to be on hotels.com. This new system will offer a more affordable option as well as greater accuracy for local business because it is regional to each charger station. The current options miss local companies that cannot afford to pay, or do not pay because they do not fit the featured categories. Yelp, Google, MapQuest often miss the less connected businesses and points of interest in smaller towns. Beyond that, SBP is designed for Local news, Chat rooms, Blogs, Postings, Videos (like an ice sculpture in the town square can be posted for visitors to know), web stores both for stores local to the charger and internet wide. I intend to use the PAYPAL® Auctions system (local and internet wide) or provide a new version. In another embodiment, the SBP offers coupons that are local to the charger and the ability to make reservations. In another embodiment, I provide exclusive or non-exclusive travel discounts that are local to the charger. In yet another embodiment, SBD features events and regional calendars that are local to the charger. In another embodiment,the SBP provides access to educational and non-profit groups, students, startups and others doing good for the community.

In yet another embodiment, I provide a GimmE button 64 that functions as a unique, “fun” selector. Whether the GimmE button is the physical version on the front of the recharger or is an on-screen software it will look the same. I intend to vary the color for material or intent. For example, when the on-screen GimmE button is red instead of green, it signifies a non-selectable item.

The SBP software is under constant development, as access is sold or given to small business, persons, groups.

My portal allows for access to other portals without leaving SBP. The GimmE feature is intended to only be available through the SBP portal. In contrast, Facebook is a closed system with strong limits on access to outside systems to protect personal information. In one embodiment, the SBPsystem is an open “pipe” allowing access to outside features/services. All likes and preferences are tagged to the customers' GOe3 charging fab and not to their personal information. For example, my system records the key fab number 00303xxx with likes for pizza and Barbie museums. In the town he is charging, there are both, and the patron sees ads for that while charging. What the TBP system will not know is that “Todd Tuffguy” likes pizza and Barbie museums, nor will anyone else. My system offers high degrees of privacy and security.

The display on the charging station is preferably quartered, allowing for four points of content (66, 68, 70 and 72). When a digital version of the GimmE button is present, it is either at the center of the four screens or along the right/left border. In another embodiment, this preference is user configurable.

The SBP system offers options of both free and purchased content. The patron has the option of using an account-linked key fab, my version of PAYPAL called PAYME, or a credit card.

On FIG. 2 between 58 and 60, there is a smaller 5.7 inch screen, that includes a programmable logic controller (PLC) added by the manufacturer to control which charger is in use.

### EXAMPLE 1

### GOe3 E3 Universal Charger

In one embodiment the E3 universal charger system has both level 3 and level 2 charging capabilities. The E3 charger provides quick charging at the 20 kW, 30 kW, 40 kW, and 50 kW rating Level 3 with the Level 2 charging at about 16.8 kW (240 Volts at 70 Amps). The Level 3 service is provided via a plurality of dissimilar adaptors with the Level 2 service also provided via a plurality of dissimilar adaptors. The adapters are the interface between the charge station and the electric vehicle to facilitate recharging of the electric vehicle battery. The adaptors have the ability to be interchangeable with respect to position, retrofit, upgrade, or repair. The E2 universal charger system charges a plurality of electric vehicles simultaneously. The E3 charger system also has an attachable shade apparatus. The shade apparatus provides cover from direct sunlight and protection from adverse weather conditions. During low light conditions the shade apparatus illuminates the E3 charger. This apparatus features mounting mechanisms for attachment to the E3 charger system, self contained solar collector and power storage system, illumination source, and security camera option. Optionally, the solar collector, power storage system, illumination source and security camera can be attached directly to the E3 charger system.

### EXAMPLE 2

### Network and Advertising Technology

The inventive charger network is composed of E3 and E2 chargers and partnered EVSE (electric vehicle supply equipment) that are networked through cell, wireless, or wired means to function as network nodes. This is the foundation of my state-to-state and nationwide recharging network. The network nodes share data between nodes and other data managing systems to push and pull advertisements and user content between servers and end users. For the end users, this content is preferably displayed on 15″ touch screen for the E3, and a smaller screen for E2. Web content may also be viewed through any technology able to connect to my multi-portal system, including, but not limited to, telephones, laptops, etc. The E3 ported content is broken into quadrants allowing for multiple channels of content. The E2 with a smaller view screen for content delivery displays in a convenient format. Interaction data between the user and the inventive system are collected and linked to the User's Number on the system. The advertising content can be customized to user preferences and to the regional area. When a user selects an ad, additional information associated with the ad is transmitted to the user. The information is received on the user's mobile device using a convenient application. Preferably, the application enables communication with the subject of the ad.

Those of ordinary skill in the art will appreciate that the foregoing description is illustrative of the invention. The disclosure is not intended to be limited to the specific embodiments described above. The details of the materials used, the uses described, and the arrangement and type of mechanical objects of the invention can be altered without materially changing the scope of the instant invention. It is to be understood that the above description has been made in an illustrative fashion, and not a restrictive one. Combinations of the above embodiments, and other embodiments not specifically described herein will be apparent to those of skill in the art. The scope of the various embodiments of the invention includes any other applications in which the extension device is used. Therefore the scope of the inventive concept, including all of it's embodiments and appended claims, along with a full range of equivalents should be considered to be the full inventive concept.

The organization of the foregoing examples and description should not be construed to be the only features of the invention, nor should the examples be limiting to the inventive concept. The claims appended to this disclosure reflect subsets of the instant invention. The appended claims, and all claims which may be later added are hereby incorporated into the description of the embodiments of the invention, with each claim standing on its own as a separate preferred embodiment.

What is claimed is:

1. An electric vehicle-charging station system comprising:
a. A plurality of charging nodes, each charging node including a charging station having at least two electric vehicle supply equipment selected from the group consisting of a Level 1 charging device, a Level 2 charging device, a TESLA charging device, and a Level 3/Fast DC charging device, wherein the plurality of charging nodes are in communication with each other through a network;
b. A display device disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle; and
c. A selection device that allows the consumer to select a particular portal, wherein the selection device transmits the selected content to a mobile device associated with the consumer.
